(19) United States
(12) Patent Application Publication
(10) Pub. No.: US 2026/0238370 A1
(43) Pub. Date: Aug. 13, 2026

(54) Optical Transmission Apparatus

(71) Applicant: NTT, Inc., Tokyo (JP)

(72) Inventors: Osamu Moriwaki, Musashino-shi, Tokyo (JP); Kenya Suzuki, Musashino-shi, Tokyo (JP); Keita Yamaguchi, Musashino-shi, Tokyo (JP)

(21) Appl. No.: 19/154,244

(22) PCT Filed: Feb. 14, 2023
(86) PCT No.: PCT/JP2023/005007

§ 371 Date: Aug. 6, 2025

(51) Int. Cl. H04J 14/02; H04J 3/16

(52) U.S. Cl. CPC H04J 14/0212; H04J 3/1652

(57) ABSTRACT

A novel optical transmission device is disclosed, including a plurality of optical cross-connect (OXC) units each including the same configuration, and a plurality of transponder aggregator (TPA) units each including the same configuration. The combination of the number of the optical cross-connect units and the number of the TPA units may be any combination. None of the OXC units is connected to each other, and each of the OXC units is connected to all the B TPA units. The wavelength of an optical signal is any wavelength, the input/output paths of the TPAs are any input/output paths, an optical signal can be branched/inserted without collision, and the CDC functions are included.

### TECHNICAL FIELD

The present invention relates to an optical transmission device used for an optical communication network.

### BACKGROUND ART

In order to cope with a rapidly increasing demand for data communication networks, optical communication networks capable of transmitting a large amount of data with low power consumption have been widely constructed. In optical communication networks, a plurality of nodes at different points is directly connected, and flexible routing is performed by an optical transmission device to which an optical switch is applied. Specifically, a ring network is adopted in a metro core network that bundles access networks connected to users. A reconfigurable-optical add drop multiplexer (CDC-ROADM) is an optical transmission device widely used in a multi-ring network that transfers an optical signal between a plurality of rings without using electrical reproduction relay (Non Patent Literature 1).

FIG. 1 is a diagram illustrating a configuration of a multi-ring network. (a) of FIG. 1 schematically illustrates a multi-ring network 10. Optical nodes 200, 220, 221, and 222 are connected to a ring 10-1 in this order in a ring shape. Optical nodes 200, 224, 222, and 223 are connected to a ring 10-2 in this order in a ring shape, and the two rings intersect at the optical nodes 200 and 222.

(b) of FIG. 1 illustrates a configuration of one optical node in the multi-ring network. The optical node 200 includes four paths A, B, C, and D formed by two rings intersecting, and corresponding optical fibers 211 to 214 are connected. In an actual optical node, as optical fibers that connect optical nodes, two (a pair of) optical fibers corresponding to two propagation directions 1-a and 1-b of light (clockwise or counterclockwise in a ring) are connected. That is, as illustrated in (c) of FIG. 1, optical fibers A, B, C, and D that enter the optical node 200 and optical fibers A′, B′, C′, and D′ that exit the optical node 200 are included. Wavelength division multiplexing (WDM) signals are transferred on the optical fibers.

In each of the optical nodes in FIG. 1, a corresponding ROADM device is installed as an optical transmission device. Although a detailed configuration of the ROADM device will be described below, in one optical node 200, a pair of optical fibers (input optical fiber and output optical fiber) is connected to a port corresponding to each of the connected paths. In the ROADM device, in addition to transfer an optical signal between any input port and output port, it is possible to extract an optical signal of any wavelength in a WDM signal from a DROP port, and conversely add an optical signal of any wavelength to a WDM signal for an ADD port. As a result, a target optical signal can be input and output without the optical signal being converted into an electrical signal, and flexible path management is implemented while an ultra-high transmission speed is maintained.

In the ROADM device, an optical signal input from an ADD port may have any wavelength, or can be output from any output port. Furthermore, optical signals of the same wavelength can be input to different ADD ports under a condition that the optical signals are not output from the same output port. Further, an optical signal output from a DROP port can be an optical signal input from any input port. In the ROADM device, CDC functions, that is, Colorless, Directionless, and Contentionless are implemented.

### CITATION LIST

### Non Patent Literature

Non Patent Literature 1: T. Watanabe, K. Suzuki and T. Takahashi: “Silica-based PLCtransponder aggregators for colorless, directionless, and contentionless ROADM,” Optical Fiber Communication Conference (OFC), Paper OTh3D.1 (2012)
Non Patent Literature 2: K. Suzuki, Y. Ikuma, E. Hashimoto, K. Yamaguchi, M. Itoh and T. Takahashi, “Ultra-high port count wavelength selective switch employing waveguide-based I/O frontend,” 2015 Optical Fiber Communications Conference and Exhibition (OFC), Los Angeles, CA, USA, 2015, pp. 1-3, doi: 10.1364/OFC.2015.Tu3A.7.

### SUMMARY OF INVENTION

### Technical Problem

In the ROADM device that transfers a WDM signal, the number of pairs of optical fibers used between optical nodes needs to be increased to two or more in order to transmit data that exceeds the maximum value of the amount of data that can be transmitted by two (a pair of) optical fibers. However, in a situation where the amount of data transmission is rapidly increasing, the number of paths handled by one optical node is also large, and many of input ports and output ports are used, and there is little room to add a pair of optical fibers to the same path to increase the number of pairs to two or more. Although a plurality of optical nodes can be installed in one location so that a new network independent of the existing network is added, the CDC functions are not expanded to the added network from the existing network's perspective. In the ROADM device of the conventional art, a pair of optical fibers cannot be smoothly added while the CDC functions are maintained in response to an increase in the amount of data.

The present invention has been made in view of the above-described issues, and provides an optical transmission device in which two or more pairs of optical fibers are added between optical nodes so as to facilitate flexible expansion of an optical network while maintaining CDC functions.

### Solution to Problem

One aspect of the present invention is an optical transmission device including: A optical cross-connect (OXC) units, each of the A OXC units including M input ports that receive a wavelength-multiplexed (WDM) signal, and M output ports that output a rerouted WDM signal; and B transponder aggregation device (TPA) units, each of the B TPA units outputting at least a part of the WDM signal from the input ports to any of N DROP ports, and outputting, from any of the output ports, an optical signal input from one of N ADD ports, in which each of the A OXC units is not connected to each other, and each of the A OXC units is connected to all of the B TPA units.

### Advantageous Effects of Invention

According to the present invention, a pair of optical fibers between optical nodes can be added while CDC functions are maintained, and optical network expansion is facilitated.

### BRIEF DESCRIPTION OF DRAWINGS

FIG. 1 is a diagram illustrating a configuration of a multi-ring network.

FIG. 2 is a diagram illustrating a configuration of an optical transmission device according to a CDC-ROADM of the conventional art.

FIG. 3 is a diagram illustrating a configuration of an optical transmission device according to a CDC-ROADM of the present disclosure.

FIG. 4 is a diagram illustrating another configuration of an optical transmission device according to the CDC-ROADM of the present disclosure.

### DESCRIPTION OF EMBODIMENTS

An optical transmission device of the present disclosure can expand the scale of an optical node by increasing the amount of data that can be transmitted while maintaining CDC functions without being restricted in the number of input ports and output ports even in a case where a pair of optical fibers is added. An ADD port that inserts an optical signal from the outside of an optical node and a DROP port that branches an optical signal to the outside of an optical node can be freely selected, and an optical fiber that inserts and branches an optical signal can be freely selected. A configuration of an optical transmission device that can flexibly change the scale according to a demand of a CDC-ROADM network is provided.

The optical transmission device of the present disclosure includes a plurality of optical cross-connect units each including the same configuration, and a plurality of transponder aggregator (TPA) units each including the same configuration. The combination of the number of the optical cross-connect units and the number of the TPA units may be any combination. The wavelength of an optical signal is any wavelength, the input/output paths of the TPAs are any input/output optical signal can be branched/inserted without collision, and the CDC functions are included.

In the following description, first, a configuration of a basic optical transmission device of the conventional art will be described, and an issue in a case where an optical fiber pair is to be added will be clarified. Thereafter, a configuration of the optical transmission device of the present disclosure will be described. The term “optical transmission device” is a device that is installed in an optical node of a multi-ring network, transfers an optical signal between optical nodes in the form of a WDM signal, and can switch a path of an optical signal. Furthermore, branching and insertion of optical signals is possible to and from the multi-ring network. The optical transmission device implements a main function of an optical node in a multi-ring network, and may be referred to as an “optical node”. Furthermore, the optical transmission device is connected to another optical transmission device by an optical fiber to optically connect different points, but there is no limitation on the installation place, and for example, a plurality of optical transmission devices may be installed in the Same office building.

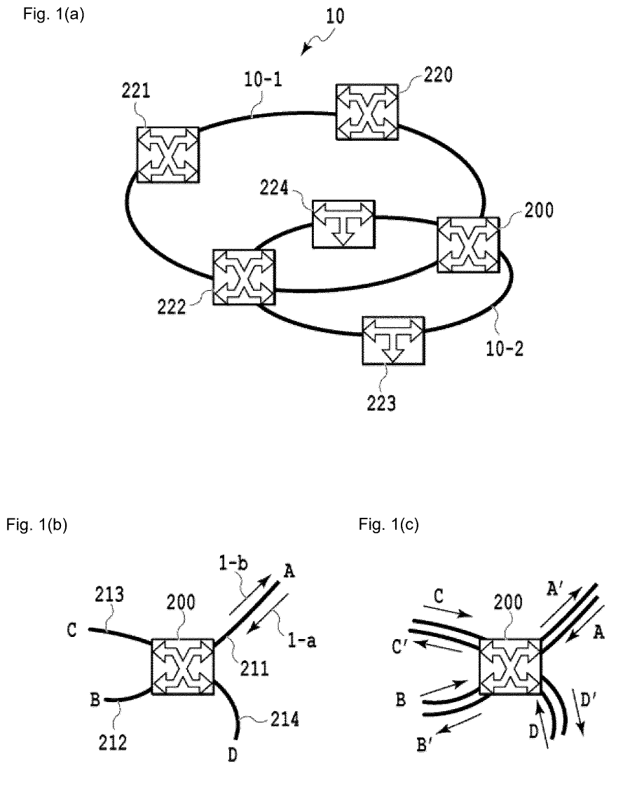

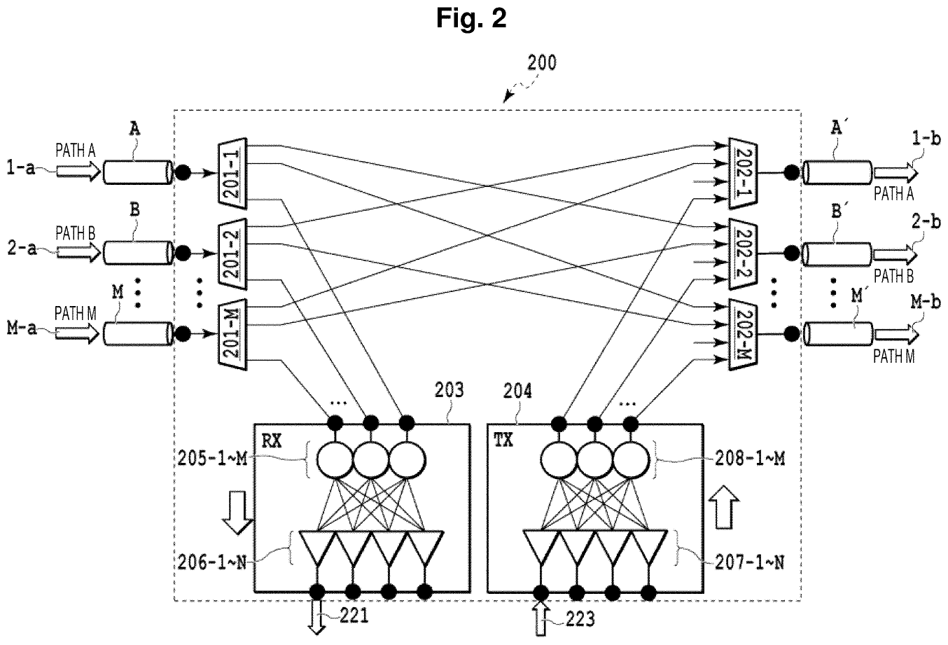

FIG. 2 is a diagram illustrating a configuration of an optical transmission device of a CDC-ROADM of the conventional art. Although an optical transmission device 200 corresponds to the optical node 200 in FIG. 1, it is assumed that path switching of an optical signal can be performed between a maximum of M paths in addition to the four paths A, B, C, and D. M WDM signals 1-a to 1-M are input to M input ports via respective input optical fibers. M input-side wavelength selective switches (WSSs) 201-1 to 201-M each including one input and L outputs are connected to the respective input ports. The M output ports of the optical transmission device 200 are connected to output-side WSSs 202-1 to 202-M of L inputs and one output. The optical transmission device 200 further includes a receiver transponder aggregator (aggregation device) (TPA) 203 of M inputs and N outputs and a transmitter TPA 204 of N inputs and M outputs.

Among the L output ports included in each of the WSSs of the input-side WSSs 201-1 to M, M-1 output ports are connected to input ports of M-1 output WSSs 202 having port numbers different from the own port numbers. That is, the wiring between WSSs of the same number that forms folded path connection is removed from a configuration in which the output ports of the input-side WSSs and the input ports of the output-side WSSs are connected in full mesh. This is because switching (folding back) an optical signal included in a WDM signal input from a certain path to the same path is usually meaningless in an optical node for transferring an optical signal and switching a path.

It should be noted that two optical fibers corresponding to the same path in FIG. 2, for example, a receiving optical fiber A and a transmitting optical fiber A′, are drawn as being diametrically opposed, but are connected toward physically the same optical node as a pair. For example, two optical fibers A and A′ of the node 200 in (c) of FIG. 1 are connected to the optical node 220 in (a) of FIG. 1.

All input ports of the receiver TPA 203 are connected to output ports of the different input-side WSSs 201-1 to 201-M. Similarly, all output ports of the transmitter TPA 204 are connected to input ports of the different output-side WSSs 202-1 to 202-M.

Each of the input-side WSSs 201-1 to 201-M includes a function of selecting an output port according to a wavelength for a WDM signal input from the input port and outputting only an optical signal of the wavelength. Furthermore, each of the output-side WSSs 202-1 to 202-M includes a function of multiplexing optical signals having different wavelengths corresponding to respective input ports in order to form a WDM signal to be output from the output port. In the receiver TPA 203, for example, M optical splitters 205-1 to 205-M each including one input and N outputs and N optical switches 206-1 to 206-N each including M inputs and one output are connected in full mesh. That is, the receiver TPA 203 is a multicast switch capable of outputting an optical signal to each of the input ports to any output port.

In transmitter TPA 204, for example, N optical switches each including one input and M outputs and M optical couplers 208-1 to 208-M each including N inputs and one output are connected in full mesh. That is, the transmitter TPA 204 is a multicast switch capable of wavelength-multiplexing as necessary and outputting an optical signal to each of the input ports to any output port.

In the optical transmission device 200 including the above-described configuration, an optical signal input (ADDed) from an input port, that is, an ADD port of the transmitter TPA 204 may have any wavelength, or a WDM signal including an optical signal ADDed from any WSS among the output-side WSSs 202-1 to M can be output. Optical signals of the same wavelength can also be input to different input ports of the transmitter TPA 204 under a condition that the optical signals are not output from the same output-side WSSs 202-1 to M. Furthermore, an optical signal output from an output port, that is, a DROP port of the receiver TPA 203 can be an optical signal input from any one WSS among the input-side WSSs 201-1 to 201-M. These functions are functions referred to as C=Colorless, D=Directionless, and C=Contentionless.

In the optical transmission device 200, an ADD function of inserting an optical signal from a user and a DROP function of branching an optical signal to a user are implemented via a transponder (not illustrated). That is, a receiver transponder is connected to each DROP port of the receiver TPA 203 in FIG. 2, and a transmitter transponder is connected to each ADD port of the transmitter TPA 204. In a transponder connected to the user, necessary signal processing is performed, and as an example, an electrical-optical conversion function is included, and also a monitoring control function, a wavelength conversion function/wavelength assignment function, and the like can be included in addition to signal processing of multiplexing control and error control.

In the multi-ring network described in FIG. 1, the optical transmission device 200 is installed in each of the optical nodes, so that a large amount of data can be transmitted. However, the upper limit of the maximum value of the amount of data that can be transmitted between two optical nodes is the number of signals that can be wavelength-multiplexed into a pair of transmission and reception optical fibers×signal speed. In order to transmit an amount of data that exceeds this upper limit, the number of pairs of optical fibers used between two optical nodes with insufficient capacity needs to be further increased to two or more pairs. In a case where two pairs of optical fibers are connected, there are two pairs of two optical fibers for transmission and reception (one pair), so that a total of four optical fibers are used.

One method of implementing addition of a pair of optical fibers in the optical transmission device 200 is to add and use a port to which a WDM signal is input and a port from which a WDM signal is output between two optical nodes with insufficient capacity. For example, if the transmission capacity of the path A is insufficient in FIG. 2, another set of an input-side WSS and an output-side WSS may be used for the path A in addition to the input-side WSS 201-1 and the output-side WSS 202-1.

However, due to structural and economic limitations of one device and technical limitations of components, the number of input ports and output ports that can be included in the optical transmission device is naturally limited. Although some optical transmission devices include about 100 ports at a research and development level (Non Patent Literature 2), the number of ports of an optical transmission device that can be practically used remains several tens (about 20). Furthermore, the number of ports of a practical transmission device is about 20 due to limitation of a parameter that can be controlled independently with high accuracy for port selection of a switch, such as a reflection angle of a mirror and the like.

Furthermore, in a traffic condition in which the upper limit of the transmission capacity between two optical nodes is reached, the number of paths to be connected in the corresponding optical nodes is also larger than that in the other case. In the optical transmission device, input ports and output ports of the optical transmission device need to be allocated for the number of paths required by the optical node with first priority. Therefore, the number of sets of an input-side WSS and an output-side WSS allocated for addition of an optical fiber pair is already limited. For example, if there are eight sets of input and output ports of the optical transmission device and the required number of paths is six, there are only two (=8−6) sets of an input-side WSS and an output-side WSS available for addition.

Another method of implementing addition of a pair of optical fibers in the optical transmission device 200 is to add another optical communication device so that there is a plurality of optical communication devices, and to increase the number of optical communication networks themselves to a plurality. If the number of optical transmission devices is increased, the number of pairs of optical fibers that connect optical nodes can be increased as a matter of course. However, even if each of the two networks includes the CDC functions, since the two networks are mutually independent networks, the CDC functions cannot be maintained in the two networks as a whole, and convenience and economy of the networks are deteriorated.

The optical transmission device of the present disclosure includes a plurality of optical cross-connect units each including the same configuration, and a plurality of transponder aggregator units each including the same configuration. Even if a pair of optical fibers is added according to an increase in data transmission capacity for the optical transmission device, an optical network can be flexibly expanded while the CDC functions are maintained.

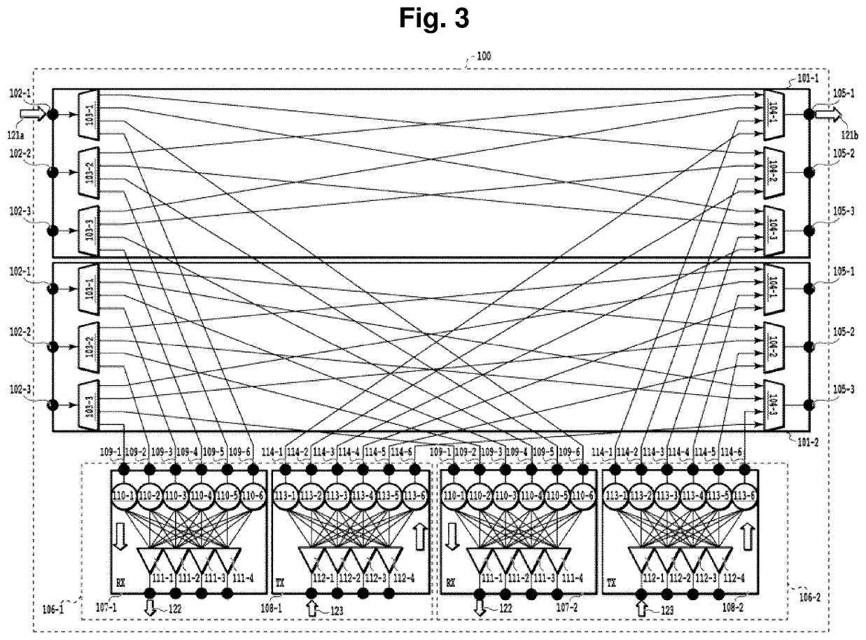

FIG. 3 is a diagram illustrating a configuration of an optical transmission device of a CDC-ROADM of the present disclosure. An optical transmission device 100 includes two optical cross-connect (OXC) units 101-1 and 101-2 and two transponder aggregator (TPA) units 106-1 and 106-2. The configuration of FIG. 3 is an example, and the number of OXC units and TPA units is any number as described below. Each of the OXC units 101-1 and 101-2 includes input-side WSSs 103-1 to 103-3 connected to input ports 102-1 to 102-3 of a WDM signal and output-side WSSs 104-1 to 104-3 connected to output ports 105-1 to 105-3 of a WDM signal. The output ports of the input-side WSSs 103-1 to 103-3 and the input ports of the output-side WSSs 104-1 to 104-3 are connected such output ports and input ports having different port numbers are connected to each other. The connection between the input-side WSSs and the output-side WSSs in one OXC unit is similar to that of the optical transmission device 200 of the conventional art in FIG. 2.

The optical transmission device 100 includes two TPA units 106-1 and 106-2, and each of the TPA units includes the same internal structure including a receiver TPA and a transmitter TPA. A receiver TPA 107-1 includes six optical splitters 110-1 to 110-6 of one input and four outputs connected to respective internal input ports 109-1 to 109-6 of the device. The receiver TPA 107-1 further includes four optical switches 111-1 to 111-4 of six inputs and one output connected to the optical splitters 110-1 to 110-6. The output ports of the optical splitters 110-1 to 110-6 and the input ports of the optical switches 111-1 to 111-4 are wired to each other such that all combinations of the optical splitters and the optical switches are connected. That is, in the receiver TPA 107-1, the internal input ports and DROP ports are connected in full mesh. Optical signals of any wavelength in a WDM signal are selected and output from the output ports, that is, DROP ports of the optical switches 111-1 to 111-4. A receiver TPA 107-2 also includes exactly the same configuration as the receiver TPA 107-1.

A transmitter TPA 108-1 includes six optical switches 112-1 to 112-4 of one input and six outputs each including an input port, that is, an ADD port of an optical signal 123. The transmitter TPA 108-1 further includes six optical couplers 113-1 to 113-6 of four inputs and one output connected to 112-1 to 112-4. The transmitter TPA 108-1 includes internal output ports 114-1 to 114-6 in the device. The output ports of the optical switches 112-1 to 112-4 and the input ports of the optical couplers 113-1 to 113-6 are wired to each other such that all combinations of the optical switches and the optical couplers are connected. That is, in the transmitter TPA 108-1, the ADD ports and the internal output ports are connected in full mesh. The internal output ports of the optical couplers 113-1 to 113-6 are connected to all the output-side WSSs of the two OXC units. The transmitter TPA operates to add the optical signal 123 of any wavelength input (ADDed) to the ADD ports to a WDM signal from any output-side WSS of the two OXC units. A transmitter TPA 108-2 also includes exactly the same configuration as the transmitter TPA 108-1.

Therefore, the optical transmission device of the present disclosure includes: A optical cross-connect (OXC) units 101-1 and 101-2, each of the A OXC units including M input ports 103-1 to 103-3 that receive a wavelength-multiplexed (WDM) signal, and M output ports 105-1 to 105-3 that output a rerouted WDM signal; and B transponder aggregation device (TPA) units 107-1 and 107-2, each of the B TPA units outputting at least a part 122 of the WDM signal from the input ports to any of N DROP ports, and outputting, from any of the output ports, an optical signal 123 input from one of N ADD ports, and can be implemented regarding that none of the A OXC units is connected to each other, and each of the A OXC units is connected to all of the B TPA units 107-1 and 107-2.

Here, each of the B TPA units includes: a receiver TPA 107-1 or 107-2 including M×A internal input ports 109-1 to 109-6 that receive at least a part of the WDM signal to the input ports and the N DROP ports, in which the internal input ports and the DROP ports are all connected to each other; and a transmitter TPA 108-1 or 108-2 including the N ADD ports and M×A internal output ports 114-1 to 114-6 that output the optical signal to any one of the output ports, in which the ADD ports and the internal output ports are all connected to each other.

In the optical transmission device 100 including the above-described configuration, the optical signal 123 input to an ADD port of the transmitter TPA 108-1 or 108-2 can be, regardless of the wavelength thereof, output as a WDM signal from any of the output ports 105-1 to 105-3 in any of the OXC units 101-1 and 101-2. Optical signals of the same wavelength may be input to different ADD ports of the transmitter TPA 108-1 or 108-2 under a condition that the optical signals are not output from the same output ports 205-1 to 3.

Furthermore, the optical signal 122 output from a DROP port of the receiver TPA 107-1 or 107-2 may be an optical signal input from any of the input ports 102-1 to 102-3 of a WDM signal in any of the OXC units 101-1 and 101-2. Optical signals of the same wavelength may be output to different DROP ports of the receiver TPA 107-1 or 107-2. Therefore, in the optical transmission device 100, the wavelength of an optical signal is any wavelength, the input/output paths of the TPAs are any input/output paths, an optical signal can be branched/inserted without collision, and the CDC functions are included.

According to the configuration of the optical transmission device 100 of the present disclosure, in a case where there is a demand to increase the number of pairs of optical fibers used between two optical nodes to two or more, an OXC unit including the same configuration can be added. In the configuration illustrated in FIG. 3, two OXC units are already included, but a function as the CDC-ROADM device may be implemented as long as a single OXC unit and a single TPA unit are included. In the configuration of FIG. 3, focusing only on the OXC unit 101-1 and the TPA unit 106-1, the configuration is substantially the same as the configuration in which M=3 is defined in the optical transmission device 200 of the conventional art of FIG. 2. Therefore, it is assumed that only the single OXC unit 101-1 of the optical transmission device 100 can switch paths as many as necessary in the optical node. In FIG. 3, the configuration (M=3) in which one OXC unit includes three input ports and three output ports is taken as an example so that all connections are easily viewed in the optical transmission device. It is a matter of course that an actual optical transmission device includes input ports and output ports as many as switching can be performed on all paths assumed in optical node.

Furthermore, when the number of input ports of the OXC unit is M and the number of TPA units is B, the number of output ports of the input-side WSS needs to be (M+B−1) or more. The number of input ports of the output-side WSS also needs to be (M+B−1) or more. Note that the WSS can also increase the number of ports by a configuration in which a WSS is further connected in cascade to the multi-port side. In a case where a small-scale WSS in which the number of input ports or the number of output ports is less than (M+B−1) is used, the number of ports can be increased to (M+B−1) or more by a configuration in which a WSS is connected in cascade.

This means that, in the optical transmission device 100, the second OXC unit 101-2 is added in response to a demand for increasing the number of pairs of optical fibers to two or more being generated. A pair of optical fibers is added to an input port and an output port of the added OXC unit 101-2. Further, it should be noted that, in the optical transmission device 100, there is no path that connects an input-side WSS and an output-side WSS between the two OXC units 101-1 and 101-2. On the other hand, all the OXC units are connected to all the TPA units. The OXC unit 101-1 is connected to both of the TPA units 106-1 and 106-2, and the OXC unit 101-2 is also connected to both of the TPA units 106-1 and 106-2. With this configuration, in a network including only the OXC unit 101-1 and the TPA unit 106-1 before addition, only the number of pairs of optical fibers increases even after addition of the OXC unit 101-2 and the TPA unit 106-2. There is no change in a topology of the optical communication network including an optical node in which the optical transmission device 100 is installed. That is, the CDC functions in the optical transmission device 100 are maintained as they are even after addition.

Further, for transceivers of the transponders connected to the TPA units 106-1 and 106-2, there is no difference between an optical signal of a WDM signal passing through the OXC unit 101-1 and an optical signal of a WDM signal passing through the OXC unit 101-2. With such characteristics, the scale can be expanded while the configuration and shape of the existing optical communication network is maintained. A receiver of a transponder connected to the TPA unit can make Colorless, Directionless, and Contentionless connection while maintaining the CDC functions for any OXC unit. In the conventional art, in a case where a transponder is connected to a TPA as in a case where an independent network is added to an optical node with insufficient transmission capacity, which optical communication network a transceiver uses does not need to be considered.

In the receiver TPA of the optical transmission device described above, an optical splitter and an optical switch are combined, and the receiver TPA functions as a multicast switch. Therefore, an optical signal that has entered the internal input ports 109-1 to 109-6 of the optical splitter is directly output to a DROP port. Here, the wavelength selection function of the WSS can be included by replacing the optical splitters 110-1 to 110-6 with the WSS. In this case, the receiver TPA functions as the WSS including an M×N configuration, and an optical signal of a specific wavelength of an optical signal that has entered an input port of the WSS appears in a DROP port. Therefore, the receiver TPA outputs at least a part of an optical signal from an output port of the input-side WSS to an internal input port from a DROP port.

The transmitter TPA of the optical transmission device 100 combines an optical switch and an optical coupler, and an optical signal that has entered an ADD port is output to one of the internal output ports 114-1 to 114-6. Here, the wavelength multiplexing function of the WSS can be included by replacing the optical coupler with the WSS. In this case, optical signals of different wavelengths that have entered from different ADD ports appear in the same internal output port. Therefore, the transmitter TPA can output an optical signal input to an ADD port to any of the internal output ports, or can perform wavelength multiplexing on two or more signal light beams of different wavelengths and collectively output the signal light beams to one internal output port.

Note that the internal input port and the internal output port in the TPA unit correspond to connection points at a boundary between the OXC unit and the TPA unit, and there is no need to include a port in a physical sense. It should be noted that the term “connection point” is used because structures/mechanisms for physically inputting and outputting an optical signal may not be necessary due to an integrated configuration.

In the optical transmission device 100, the optical coupler or the optical splitter and the optical switch included in the receiver TPA and the transmitter TPA, respectively, can be integrated and manufactured by a technology for a silica-based planar lightwave circuit (PLC) formed on a Si substrate. It can be expected to obtain good optical characteristics at low cost by using the PLC technology. Further, the same function can be implemented by using a wavelength selective switch in the TPA unit instead of the optical coupler or the optical splitter.

In the case of the configuration of FIG. 3, the WSS included in the OXC unit in the optical transmission device of the present disclosure can be formed by replacing the input side with an optical switch including one input and four outputs and the output side with an optical switch including four inputs and one output, for example. In this case, a function of controlling a path in units of wavelengths of an optical signal in the OXC unit is lost. However, optical switches for the same path that belong to different OXC units can be integrated and manufactured by the technology for a PLC formed on a Si substrate, and it can be expected to obtain good optical characteristics at low cost.

In the optical transmission device of the present disclosure, there is a plurality of optical connections in the same direction, including an input port and an output port of a WDM signal, a connection between WSSs, a connection between a WSS and a TPA unit, and the like. By applying a multicore fiber to these optical connections, space saving and simplification of wiring can be implemented.

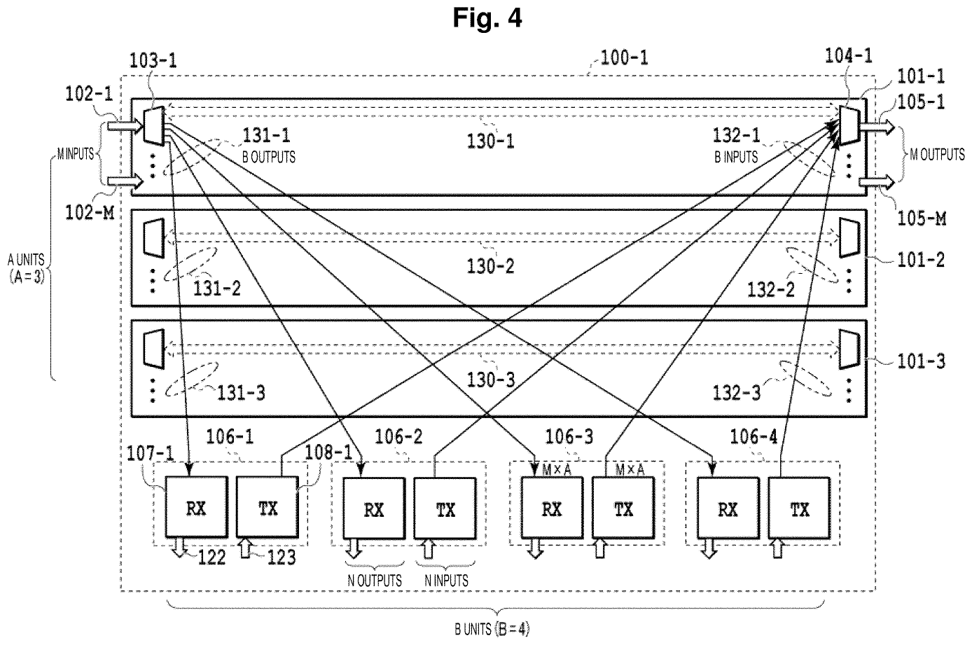

FIG. 4 is a diagram illustrating another configuration of an optical transmission device of the present disclosure in a more generalized manner. An optical transmission device 100-1 includes A (A=3) OXC units 101-1 to 101-3 and B (B=4) TPA units 106-1 to 106-4. Each of the OXC units includes M input ports and M output ports, and includes M input-side WSSs 102-1 to 102-M and M output-side WSSs 104-1 to 104-M. The input-side WSSs and the output-side WSSs are connected to each other except for WSSs of the same numbers (103-1 to 130-3). Each of the input-side WSSs is connected to all of receiver TPAS (RXs) of B TPA units (131-1 to 131-4). Each of the output-side WSSs is also connected to all of transmitter TPAs (TXs) of the B TPA units (132-1 to 132-4).

The TPA units 106-1 to 106-4 include respective receiver TPAs 107-1 to 107-4 that branch the optical signal 122 from a DROP port and respective transmitter TPAs 108-1 to 108-4 that insert the optical signal 123 from an ADD port. Each of the receivers TPAs 107-1 to 107-4 includes M×A input ports and N DROP ports, and includes the same configuration. Each of the transmitter TPAs 108-1 to 108-4 includes N ADD ports and M×A input ports, and includes the same configuration.

A configuration example of the optical transmission device 100-1 is illustrated in which there are three OXC units (A=3) including the same configuration and there are four TPA units (B=4) including the same configuration. Since each of the number of the input ports of the receiver TPA of the TPA unit and the number of the output ports of the transmitter TPA of the TPA unit is M×A, the size of the TPA unit increases as the number of OXC units increases. It should be noted that the number A of the OXC units may also be limited due to the limitation of the number of ports that can be actually implemented in the TPA.

Furthermore, as the number B of the TPA units increases, more output ports of the input-side WSS and more input ports of the output-side WSS need to be allocated for the TPA units. For example, the number M of ports on the multi-port side of the WSS is eight, and the number of paths connected to an optical node is five. At this time, one path for folding back to the same path is reduced so that 8−(5−1)=4 is obtained, and accordingly, the number of ports in the WSS that can be allocated for the TPA units is only four. Therefore, the required number of output ports of the input-side WSS and the required number of input ports of the output-side WSS are (M+B−1) or more. In this manner, various limitations of the element device including the number of ports of the TPA units, the number of ports of the WSSs, and the like may be imposed. However, among various limitations on the components of the optical transmission device, there are no limitations on the number A of the OXC units, the number B of the TPA units, and the combination in the optical transmission device 100-1.

It should be noted that, in the optical transmission device 100-1 of FIG. 4, there is no path that connects an input-side WSS and an output-side WSS among the three OXC units 101-1, 101-2, and 101-3. Among the three OXC units, one OXC unit is connected to all paths of an optical node in which the optical transmission device 100-1 is installed. Two OXC units other than the OXC unit are used for addition of an optical fiber pair. On the other hand, each of the OXC units is connected to all of the four TPA units 106-1 to 106-4.

According to the present invention, a pair of optical fibers between optical nodes can be added while CDC functions are maintained, and optical network expansion is facilitated.

### INDUSTRIAL APPLICABILITY

The present invention can be used for optical communication.

1. An optical transmission device comprising:
A optical cross-connect (OXC) units, each of the A OXC units including M input ports that receive a wavelength-multiplexed (WDM) signal, and M output ports that output a rerouted WDM signal; and
B transponder aggregation device (TPA) units, each of the B TPA units outputting at least a part of the WDM signal from the input ports to any of N DROP ports and outputting, from any of the output ports, an optical signal input from one of N ADD ports,
wherein each of the A OXC units is not connected to each other, and
each of the A OXC units is connected to all of the B TPA units.

2. The optical transmission device according to claim 1,
wherein each of the B TPA units includes:
a receiver TPA including M×A internal input ports that receive at least a part of the WDM signal to the input ports and the N DROP ports, in which the internal input ports and the DROP ports are all connected to each other; and
a transmitter TPA including the N ADD ports and M×A internal output ports that output the optical signal to any one of the output ports, in which the ADD ports and the internal output ports are all connected to each other.

3. The optical transmission device according to claim 2,
wherein the receiver TPA
includes M×A optical splitters including one input and N outputs, and N optical switches including N inputs and one output, in which the optical splitters and the optical switches are all connected to each other, or
includes M×A wavelength selective switches (WSSs) including one input and N outputs, and N optical switches including N inputs and one output, in which the WSSs and the optical switches are all connected to each other, and
the transmitter TPA
includes an optical switch including one input and N outputs, and M×A optical couplers including N inputs and one output, in which the optical switch and the optical couplers are all connected to each other, or
includes an optical switch including one input and N outputs, and M×A WSSs including N inputs and one output, in which the optical switch and the WSSs are all connected to each other.

4. The optical transmission device according to claim 1,
wherein each of the A OXC units
includes M input-side wavelength selective switches (WSSs) including the input ports and (M+B−1) or more output ports, and M output-side WSSs including (M+B−1) or more input ports and the output ports, or
includes M input-side optical switches including the input ports and (M+B−1) or more output ports, and M output-side optical switches including (M+B−1) or more input ports and the output ports.

5. The optical transmission device according to claim 3, wherein the receiver TPA and the transmitter TPA are waveguide-type optical switches manufactured by a technology for a planar lightwave circuit formed on a silicon substrate and made of silica-based glass containing SiO2 as a main component, and are driven by using a thermo-optical effect.

6. The optical transmission device according to claim 4, wherein the input-side optical switches and the output-side optical switches are waveguide-type optical switches manufactured by a technology for a planar lightwave circuit formed on a silicon substrate and made of silica-based glass containing SiO2 as a main component, and are driven by using a thermo-optical effect.

7. The optical transmission device according to claim 2, wherein a multicore fiber is connected to the input ports, the output ports, the internal input ports, or the internal output ports.
